(19) United States
(12) Patent Application Publication
(10) Pub. No.: US 2003/0210820 A1
(43) Pub. Date: Nov. 13, 2003

(54) Method and device for localizing a structure in a measured data set

(76) Inventors: Rainer Lachner, Poing-Angelbrechting (DE); Christof Ruch, Munchen (DE); Stefan Vilsmeier, Kufstein (AT)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/430,906

(22) Filed: May 7, 2003

Related U.S. Application Data
(60) Provisional application No. 60/437,414, filed on Dec. 31, 2002.

(30) Foreign Application Priority Data
May 7, 2002 (EP) 02 009 386.0

(51) Int. Cl. G06K 9/62; G06K 9/00

(52) U.S. Cl. 382/209; 382/128

(57) ABSTRACT

A method for automatically localizing at least one structure in a data set obtained by measurement includes predetermining a reference data set and determining a mapping function. The reference data set is mapped onto the measured data set. The method further includes transforming a reference label data set, which is assigned to the reference data set, into an individualized label data set using the determined mapping function.

### RELATED APPLICATION DATA

This application claims priority of U.S. Provisional Application No. 60/437,414 filed on Dec. 31, 2002, which is incorporated herein by reference in its entirety.

### FIELD OF THE INVENTION

The present invention relates generally to a method and a device for automatically localizing, measuring and/or visualizing at least one structure in an image or in a data set obtained by measurement and, more particularly, to a method and a device for automatically localizing particular brain structures or bone structures in images recorded using a nuclear spin resonance method.

### BACKGROUND OF THE INVENTION

In order to examine persons, such as in order to prepare surgical treatments or operations, particular patient areas of interest are often imaged using known methods, such as, for example, computer tomography (CT), nuclear spin resonance (MRI) or ultrasound methods. These imaging methods provide a patient-specific data set, such as, for example, tomographs of an area of the brain shown by various grey-scale value distributions.

In order to examine the patient or to prepare a treatment or an operation, it is often important to determine which anatomical structure is assigned to a particular grey-scale value distribution of an image measured in this way. For example, it can be important to localize outlines of a particular area of the brain or the surfaces of a bone in an image. These anatomical structures are not always easy to identify precisely due to anatomical circumstances, such as structures lying close to one another, as in the case of the hips and femur, the femur, patella and tibia, or adjacent vertebrae. Images of such areas often appear as a single, connected bone structure, whose exact boundaries must however be identified in order to, for example, insert a new knee or hip joint.

U.S. Pat. No. 5,633,951 proposes mapping two images obtained from different imaging methods, such as, for example, nuclear spin resonance and computer tomography, onto each other. For aligning these images, a first surface is obtained from one image using individual scanning points, which define a particular feature of an object, and the surface of the first image is superimposed onto a corresponding surface of the second image. This method, however, is very costly, requires surfaces to be determined before aligning the images and does not provide any information with regard to the exact position of particular structures, such as the boundary areas of adjacent vertebrae.

U.S. Pat. No. 5,568,384 describes a method for combining three-dimensional image sets into a single, composite image, where the individual images are combined on the basis of defined features of the individual images corresponding to each other. In particular, surfaces are selected from the images and used to find common, matching features. This method, however, also does not enable the outlines of structures, such as, for example, a particular vertebra closely bordering an adjacent vertebra, to be localized.

A method for registering an image comprising a high-deformity target image is known from U.S. Pat. No. 6,226,418 B1. In this method, individual characteristic points are defined in an image and corresponding points are identified in the target image in order to calculate a transformation from these, using which the individual images can be superimposed. However, this method cannot be carried out automatically and is, consequently, very time-consuming due to its interactive nature.

U.S. Pat. No. 6,021,213 describes a method for image processing, wherein an intensity limit value for particular parts of the image is selected to identify an anatomical area. A number of enlargements or expanding processes of the area are performed using the limit value, until the identified area fulfils particular logical restrictions of the bone marrow. This method is relatively costly and has to be performed separately for each individual anatomical area of interest.

In order to exactly localize particular structures in, for example, nuclear spin resonance images, it is often necessary for particular anatomical structures of interest to be manually identified and localized by an expert. This is typically accomplished by individually examining the images taken and highlighting the structures based on the knowledge of the specialist, for example, by using a plotting program or particular markings. This is a very time-consuming, labor-intensive and painstaking task, which is largely dependent on the experience of the expert.

### SUMMARY OF THE INVENTION

It is an object of the present invention to propose a method and a device for automatically localizing at least one structure in a data set obtained by measurement, such as, for example one or a number of computer tomographic images, using which an anatomical structure can be localized in the data set fully automatically, within a short period of time.

According to one aspect of the invention, the method is directed to a method for automatically localizing at least one anatomical structure in a data set obtained by measurement. The measured data set, such as, for example, one or more images having a defined positional relationship to each other or a volumetric or three-dimensional data set, can be compared to a predetermined reference data set, such as, for example, a reference image. A function for mapping the reference data set onto the measured data set can be determined using known methods and algorithms based, for example, on the intensity distribution in the respective data sets. Such known methods include those described in:

A. W. Toga, ed., Brain Warping. San Diego: Academic Press, 1999;

G E Christensen, Rabbit, R D, M I Miller. 3D brain mapping using a deformable neuroanatomy. Physics in Medicine and Biology, March 1994, (39) pp. 609-618;

Morten Bro-Nielsen, Claus Gramkow: Fast Fluid Registration of Medical Images. VBC 1996: 267-276;

J.-P. Thirion. Image matching as a diffusion process: an analogy with Maxwell's demons. Medical Image Analysis, 2(3):243-260, 1998;

P. Cachier, X. Pennec, and N. Ayache. Fast Non-Rigid Matching by Gradient Descent: Study and Improvements of the Demons Algorithm. Research Report 3706, INRIA, June 1999,

each of which is incorporated herein by reference in its entirety.

The reference data set can be, for example, the Talairach brain atlas, an artificially generated reference model or a reference model obtained from actual images or measurements. For example, one or more reference persons or a reference body can be examined using the same method as the person currently being examined or using a different method, such as, for example, nuclear spin resonance or computer tomography. A comparison can be made between the data set obtained by measurement and the reference data set using, for example, intensities or brightness values of the pixels or voxels contained therein, which makes the use of particular user-defined individual features such as points, curves and surfaces superfluous. Based on the comparison between the data set obtained by measurement and the reference data set, a mapping function including, for example, mapping instructions for pixels or voxels can be determined, which maps the reference data set onto the data set obtained by measurement. Alternatively, an inverse function can be determined, which maps the data set obtained by measurement onto the reference data set. The mapping function can be used to map a so-called label data set, which is assigned to the reference data set. Label data sets can be assigned to reference data sets, such as, for example, the Talairach brain atlas mentioned above or another anatomical atlas, and contain information corresponding to part of the two-dimensional or three-dimensional reference data set of a particular anatomical structure or function, i.e., the label data set contains the anatomical assignment or description of the anatomical structures of the reference data set.

If the mapping function for mapping the reference data set onto the data set obtained by measurement is known, then the same mapping function can be used to map the label data set assigned to the reference data set onto an individualized label data set assigned to the data set obtained by measurement, (i.e., which defines what for example the anatomical structures in the data set obtained by measurement are like). The reference label data set mapped in accordance with the invention by the mapping function thus represents an individualized label data set using which, for example, all the anatomical structures in the data set obtained by measurement can be localized. This method can run fully automatically and no interaction or manual processing by an expert is required.

In accordance with one embodiment, the data values of the reference data set can be obtained by examining one or more reference patients or reference bodies. The same imaging method can be used as is used to obtain the data set generated by measurement, such as, for example, computer tomography (CT), nuclear spin resonance (MRI), positron emission tomography (PET), ultrasound or the like. This generates data sets that can easily be compared with each other. This has the advantage that the reference patient or reference body is exactly analyzed or examined when generating the reference label data set. In other words, the reference data set can be manually evaluated in a known way, to generate the reference label data set which contains, for example, information on the arrangement or delineation of particular anatomical structures in the reference data set. Mean values can also be formed from a number of reference data sets or reference label data sets, for example, by examining a number of reference patients in order to obtain reference data sets, together with the corresponding reference label data sets, which may be applied and employed as generally as possible. Alternatively or additionally, it is also possible to fall back on known data sets, such as, for example, the Talairach brain atlas mentioned above or other available anatomical atlases.

The method in accordance with the invention can be used both with two-dimensional initial data sets, such as images of a particular incision plane through a body, or also with three-dimensional measured data sets, represented, for example, by voxels, in order to identify anatomical structures in the respective data sets. The corresponding data sets can be compared with corresponding two-dimensional or three-dimensional reference data sets in order to generate a mapping function, which is applied to the reference label data sets, to obtain a two-dimensional or three-dimensional individual label data set assigned to the corresponding measured two-dimensional or three-dimensional data set.

In one embodiment, admissible operators for changing or warping the data set can be used to obtain the mapping function. These include translating, shifting, rotating, deforming or shearing, each of which can be combined according to the manner of the measured data sets and reference data sets, to map the reference data set onto the measured data set two-dimensionally or three-dimensionally using a mapping function. Three-dimensionally, a mapping instruction, such as a shifting vector, can be assigned to each voxel of the reference data set, in order to map the voxel of the reference data set onto the corresponding voxel of the measured data set. Due to the large differences between the individual measured data sets, it is generally not sufficient to use basic affine mapping, such that an automatic fluid-elastic registration algorithm can be used, which maps the reference data set onto the patient data set or registers it as easily as possible. This typically deforms or warps the reference data set elastically.

It can be advantageous to select the admissible operators such that particular anatomical ancillary conditions are maintained, i.e., that no self-penetrating surfaces, discontinuities or fractures in the anatomical structures are generated by mapping. If, for example, injured or fractured anatomical structures are present, such as a broken vertebra, then the ancillary conditions mentioned above cannot or can only partially be predetermined, allowing for example discontinuities or fractures.

The mapping function can be calculated hierarchically in a number of stages. First, for example, the reference data set and/or the measured data set can be roughly aligned by a rigid translation, i.e., only shifting and rotating, such that said data sets approximately match. When capturing data in the area of the head, for example, the data representing the head can be approximately superimposed and aligned with respect to each other. The viewing direction of the heads defined by the respective data sets, for example, can be approximately the same. An elastic transformation, possibly also in combination with a further rigid transformation, is then carried out, wherein enlarging, reducing or shearing operators can be used.

Preferably, a suitable data set can be selected automatically or by manual selection from a predetermined number of reference data sets. The data set will, preferably, already match the measured data set to as great an extent as possible and only require a small number of rigid and/or elastic transformations. Thus, for example, reference data sets can be predetermined for children, adolescents, adults, women, men, tall persons, short persons, fat persons or thin persons. Also reference data sets can be predetermined for specific injuries, such as, for example, a meniscus injury or a hip injury, or also for particular areas of infected tissue, such as, for example, a brain tumor in a particular, known area. The reference data sets can then be mapped onto the measured data sets by the transformations to be determined, which form the mapping function, in order to map correspondingly assigned reference label data sets onto individualized label data sets using the mapping function thus determined.

In one embodiment, the method can be used to segment or separate bones or vertebrae. This is valuable because in computer tomography images, for example, the bones or vertebrae, which often lie close to each other, can no longer be individually distinguished and appear as a large, continuous bone structure. This is particularly true in the case of the hips and femur, the femur, patella and tibia, or adjacent vertebrae. If, for example, only individual bone structures are to be distinguished from each other, then it can be sufficient to indicate only one or more bone structures in the assigned reference data set as the reference label data set. The function or structure of the tissue outside the bone is not important in this case. Due to the relatively high contrast between the bone and the surrounding soft tissue, for example, in computer tomography, it is relatively simple, in a first step, to localize a continuous bone structure, which is to be sub-divided into individual anatomical elements, such as, for example, vertebrae. Bones and cartilage generally have roughly the same appearance, such that a reference data set can be relatively easily mapped onto a measured data set. Using the mapping function thus obtained, the reference label data set, which contains information regarding the structural boundaries of individual bone elements in the reference data set, can also be mapped onto the individualized label data set, which contains information with respect to the anatomical structures, such as their spatial delimitation, boundary areas or their extent.

Thus, once the reference data set and the measured data set have been registered or aligned, the boundaries or adjacent surfaces from the reference label data set can be determined in the measured data set. This can be accomplished by using the determined mapping function for generating the individualized label data set, and thus a structure appearing in an image as a large, continuous unit can be sub-divided into individual components, such as for example vertebrae.

In accordance with another aspect, the present invention relates to a computer program, which performs one or more of the method steps described above when it is loaded in a computer or run on a computer. The invention further relates to a program storage medium or a computer program product containing or storing such a program.

In accordance with another aspect, the invention relates to the use of the method described above for preparing or planning a surgical operation or a treatment, such as in the area of brain surgery or radio-surgery.

In accordance with another aspect, the invention relates to a device for automatically localizing at least one structure in a data set obtained by measurement. The device for automatically localizing can include an input device for inputting a measured data set, a data base in which at least one reference data set together with a corresponding reference label data set is stored, and a computational unit, which performs one or more of the method steps described above.

The device can include a measuring device, such as, for example, a computer tomograph, a nuclear spin resonance device or the like, to obtain corresponding data sets for a patient or a body. The system can include a data output device, such as, for example, a screen, on which, for example, the measured data set in a particular incision plane, a reference data set and the information assigned to the reference label data set or the individualized label data set, superimposed as appropriate onto the reference data set or the measured data set, can be displayed.

### BRIEF DESCRIPTION OF THE DRAWINGS

These and further features of the present invention will be apparent with reference to the following description and drawings, wherein:

FIG. 1 is a diagrammatic illustration of a method and a device for localizing at least one structure in accordance with the invention;

FIG. 2 illustrates exemplary cross-sectional views of a scanned brain in three orthogonal views (the patient data set) for use with the present invention;

FIG. 3 illustrates exemplary reference views with labels marked which approximately correspond to the scanned views shown in FIG. 2;

FIG. 4 illustrates the views shown FIG. 3 after being deformed or mapped using a mapping function including deformed labels in accordance with the present invention;

FIG. 5 illustrates individualized or deformed labels which have been superimposed onto the patient data set shown in FIG. 2; and

FIG. 6 illustrates exemplary patient images which have been scanned in from top to bottom (first line), reference images after a rigid transformation (second line) and reference images after an elastic transformation (third line).

### DETAILED DESCRIPTION OF THE INVENTION

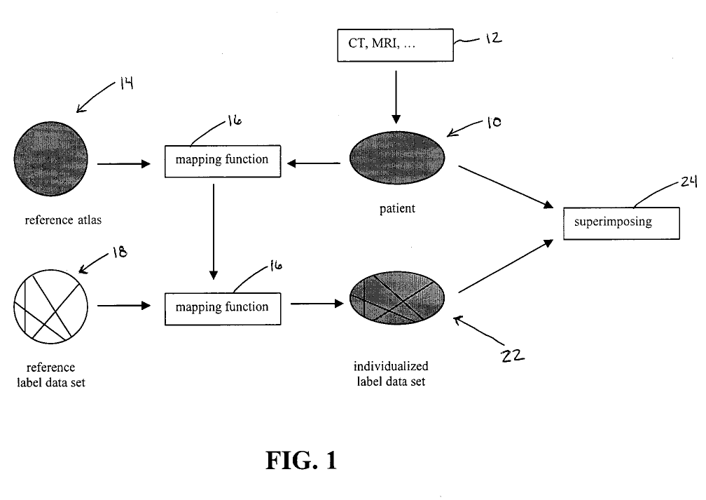

With reference to FIG. 1 a method for automatically localizing at least one structure in a data set obtained by measurement is provided. A patient-specific data set 10 can be determined from data sets obtained or scanned using computer tomography (CT), nuclear spin resonance (MRI) or other methods 12, and including, for example, a particular part of a patient's body. A predetermined reference data set 14, such as, for example, the Talairach brain atlas, can be selected and a mapping function 16 can be searched for. The reference data set 14 can be mapped onto the patient data set 10 using the mapping function 16. This mapping function 16 defines, for example, how individual elements of the reference data set 14 are shifted in order to approximately correspond to the patient data set 10.

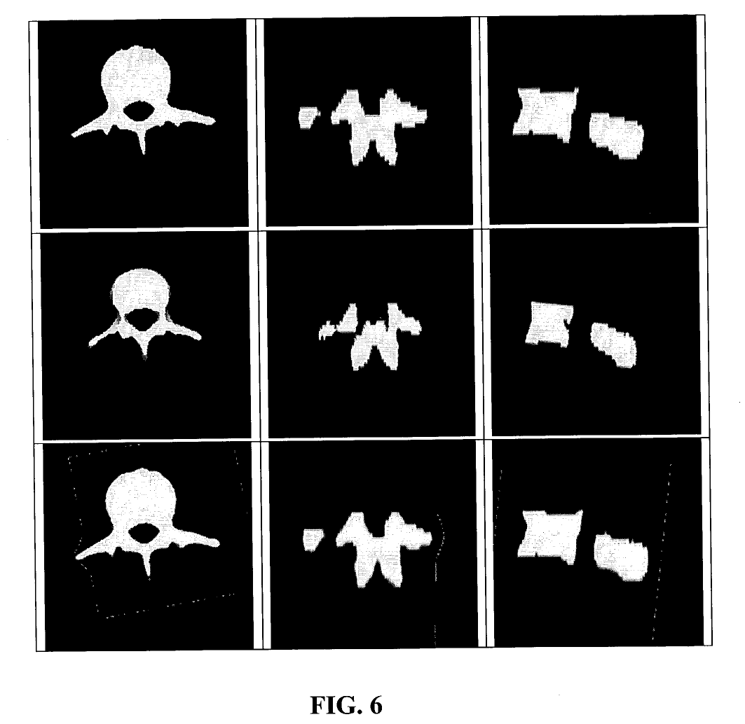

A reference label data set 18 can be assigned to the reference data set 14. The reference label data set 18 can contain information with respect to the reference data set 14 predetermined, for example, as an intensity or grey-scale value distribution. A reference label data set 18 can, for example, describe the arrangement and delineation of the anatomical structures in the reference data set 14. If the mapping function 16 for mapping the reference data set 14 onto the patient data set 10 is known, then it can be used to map or transform the reference label data set 18 accordingly, to obtain an individualized label data set 22, which can be superimposed 24 onto the patient data set 10, as shown by way of example in FIG. 1. As is described more fully below, this methodology can be used to generate the exemplary images shown in FIG. 5. The individualized label data set 22 contains information regarding the anatomical structures in the measured patient data set 10, which is initially predetermined merely as, for example, an intensity distribution.

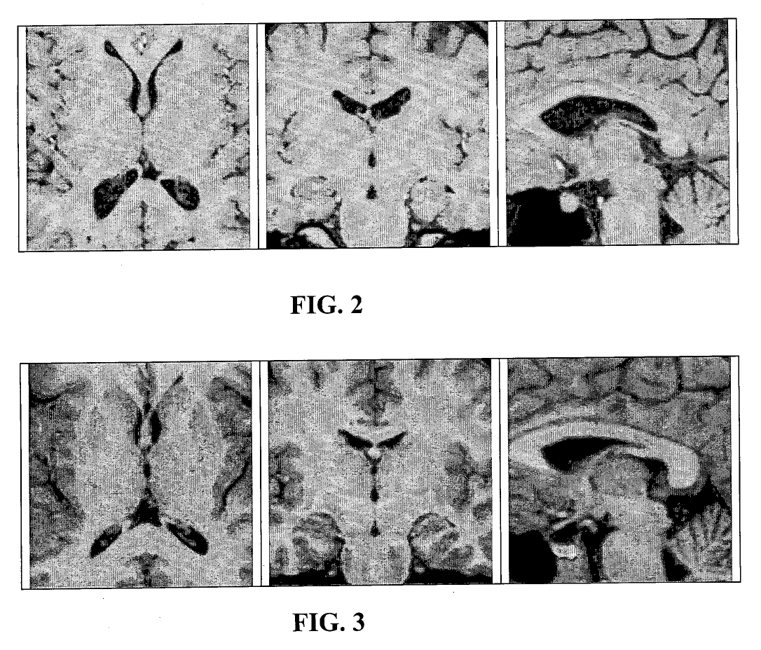

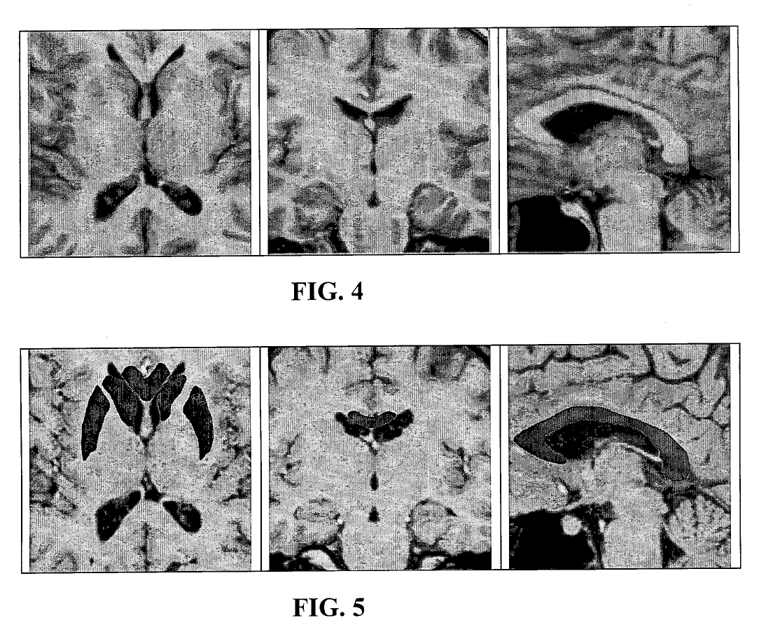

FIG. 2 shows, by way of example, scanned or measured tomographs of a patient's brain in three orthogonal views. FIG. 3 shows a predetermined reference data set for the three corresponding views from FIG. 2, with the reference data set showing approximately the same areas. In accordance with the invention, a mapping function can be determined, which warps the images shown in FIG. 3 in such a way that they approximately correspond to the scanned images shown in FIG. 2. The result of transforming the reference images shown in FIG. 3 is shown in FIG. 4, which approximately matches the scanned-in images shown in FIG. 2. The mapping function thus determined is used to transform a reference label data set (not shown) in order to obtain an individualized label data set, which is shown in FIG. 5 as superimposed areas on the background of the scanned patient images shown in FIG. 2. FIG. 5 shows the position of particular brain structures, for example, the corpus callosum, the caudate nuclei and the putamina, in the scanned-in patient images from FIG. 2.

FIG. 6 illustrates another exemplary embodiment of the method in accordance with the invention. In the first horizontal line of images in FIG. 6, a vertebra is shown in an axial view, and, orthogonal to this, in a coronal and a sagittal view. These views can be scanned in or otherwise obtained using a computer tomography scan of a patient. In the second horizontal line of images in FIG. 6, correspondingly aligned reference images are shown, which, by being shifted and rotated into approximately corresponding positions, have been moved to correspond to the scanned-in images of the first line. Once the reference images shown in the second line have been elastically transformed, by shearing, rotating and compressing, the images shown in the third horizontal line of images in FIG. 6 have been obtained, which approximately correspond to the scanned-in images shown in the first line. In the reference images shown in the second line, the course of the boundary areas of the bones is known. Once these images have been elastically transformed, so as to correspond to the scanned-in images as well as possible, then by applying the transformation method in accordance with the invention to the known course of the boundary surfaces of the reference images, it can be determined how the anatomical structures shown in the scanned-in images of the first line run, and thus the surfaces of the individual bones, for example, can be determined.

Although particular embodiments of the invention have been described in detail, it is understood that the invention is not limited correspondingly in scope, but includes all changes, modifications and equivalents coming within the spirit and terms of the claims appended hereto.

What is claimed is:

1. A method for automatically localizing at least one structure in a data set obtained by measurement, said method comprising:
a) predetermining a reference data set;
b) determining a mapping function;
c) mapping the reference data set onto the measured data set; and
d) transforming a reference label data set, which is assigned to the reference data set, into an individualized label data set using the determined mapping function.

2. The method as set forth in claim 1, wherein said reference data set is determined using the same measuring method as is used to obtain said measured data set.

3. The method as set forth in claim 1, wherein the data sets represent two-dimensional images or three-dimensional volumes.

4. The method as set forth in claim 1, wherein the mapping function includes at least one of (i) a transforming operator, (ii) a rotating operator, (iii) a shearing operator, and (iv) a deforming operator.

5. The method as set forth in claim 1, wherein the mapping function is determined using a hierarchical method including performing a rigid transformation and an elastic transformation.

6. The method as set forth in claim 1, wherein the reference data set is selected from a number of predetermined reference data sets, depending on characteristics of an object characterized by the measured data set.

7. The method as set forth in claim 1, wherein the method is used to localize brain structures.

8. The method as set forth in claim 1, wherein the method is used to localize bone structures.

9. The method as set forth in claim 1, wherein the method is used to segment individual bones.

10. A computer program which, when run on a computer or loaded onto a computer, carries out the steps as set forth in claim 1.

11. A program storage medium or a computer program product comprising the program as set forth in claim 10.

12. A method for localizing at least one structure in a measured patient data set, said method comprising:
determining a reference data set and a corresponding reference label data set;
determining a mapping function based on the measured patient data set and the reference data set; and
transforming the reference label data set into an individualized label data set using the determined mapping function, said individualized label data set being indicative of structures present in the measured patient data set.

13. The method as set forth in claim 12, further comprising:
superimposing the individualized label data set onto the measured patient data set.

14. A device for localizing at least one structure in a data set obtained by measurement, said device comprising:
a data input device which receives the data set obtained by measurement;
a memory which stores a reference data set together with a corresponding reference label data set; and
a processor which determines a mapping function for mapping the reference data set onto the measured data set and for mapping said reference label data set onto an individualized label data set, using the determined mapping function.

15. The device as set forth in claim 14, further comprising a measuring device for capturing a patient data set.

16. The device as set forth in claim 14, further comprising a data output device for displaying the measured data set, the reference data set, the reference label data set and the individualized label data set.
